(19) United States
(12) Patent Application Publication
(10) Pub. No.: US 2019/0097299 A1
(43) Pub. Date: Mar. 28, 2019

(54) INTEGRATED TRANSCEIVER FOR ANTENNA SYSTEMS

(71) Applicant: Kymeta Corporation, Redmond, WA (US)

(72) Inventors: David Fotheringham, Redmond, WA (US); Mersad Cavcic, Redmond, WA (US); Hamid Torabi, Kirkland, WA (US)

(21) Appl. No.: 16/136,811

(22) Filed: Sep. 20, 2018

Related U.S. Application Data
(60) Provisional application No. 62/562,211, filed on Sep. 22, 2017.

(51) Int. Cl. H01Q 1/02; H01Q 1/24

(52) U.S. Cl. CPC H01Q 1/02; H01Q 1/24

(57) ABSTRACT

Integrated transceivers for antenna systems are disclosed. For one embodiment, an antenna system includes an antenna having a plurality of antenna components, and a transceiver integrated into a structure of the antenna. The transceiver dissipates heat away from the antenna and does not require an internal thermal management system. For one embodiment, the transceiver dissipates heat away from the antenna into an environment by convection. For one embodiment, one of the antenna components is adjacent and thermally coupled to the transceiver. The adjacent antenna component thermally coupled to the transceiver can transfer heat away from the antenna into the environment by conduction, convection, and/or radiation. The transceiver can be integrated into the antenna according to any number of examples and variations. For example, the transceiver can be externally mounted, internally mounted or edge mounted and integrated with the antenna. In another example, components of the transceiver such as a block up-converter (BUC), low-noise block converter (LNB), and a diplexer can create a radio frequency (RC) chain and be embedded and integrated into the backend of the antenna.

### PRIORITY

This application claims priority and the benefit of U.S. Provisional Patent Application No. 62/562,211, entitled “INTEGRATED TRANSCEIVER,” filed on Sep. 22, 2017, which is hereby incorporated by reference and commonly assigned.

### FIELD

Embodiments of the invention are in the field of communications including satellite communications, antennas and related devices. More particularly, embodiments of the invention relate to integrated transceivers for antenna systems.

### BACKGROUND

Satellite communications involve transmission of microwaves. Microwaves can have small wavelengths and be transmitted at high frequencies in the gigahertz (GHz) range. Satellite antennas can produce focused beams of high-frequency microwaves or radio frequency (RF) signals that allow for point-to-point communications having broad bandwidth and high transmission rates. Antennas often use transceiver components to connect the satellite antenna to a modem, e.g., a flat panel antenna system will use a number of components that may include a diplexer, low-noise block converter (LNB) and a block up converter (BUC). Traditional satellite antennas have discrete cube shaped components designed for parabolic antennas and do not provide optimal form factors, simple design for integrated mass production, and/or an effective solution for environmental considerations such as dissipating heat from transceiver components. Such transceiver components are designed as stand-alone parts having internal thermal management systems, which do not lead to low profile or integrated transceiver designs with satellite antenna designs.

### SUMMARY

Integrated transceivers for antenna systems are disclosed. For one embodiment, an antenna system includes an antenna having a plurality of antenna components, and a transceiver integrated with a structure of the antenna. The transceiver dissipates heat away from the antenna and does not require an internal thermal management system. For one embodiment, the transceiver dissipates heat away from the antenna into an environment by convection. For one embodiment, one of the antenna components is adjacent and thermally coupled to the transceiver. The adjacent antenna component thermally coupled to the transceiver can transfer heat away from the antenna into the environment by conduction, convection, and/or radiation. The antenna system also includes a single transition pin to couple the output of the transceiver to the antenna. The transceiver can be integrated into the antenna according to any number of examples and variations. For example, the transceiver can be externally mounted, internally mounted or edge mounted and integrated with the antenna. In another example, components of the transceiver such as a block up-converter (BUC), low-noise block converter (LNB), and a diplexer can create a radio frequency (RF) chain that can be embedded and integrated into the structure of the antenna.

Other apparatuses, systems, and methods for integrated transceivers are described.

### BRIEF DESCRIPTION OF THE DRAWINGS

The appended drawings illustrate examples and embodiments and are, therefore, exemplary and not considered to be limiting in scope.

FIGS. 1A-1B illustrate exemplary block diagrams of an integrated transceiver with an antenna and thermally coupled with at least one adjacent antenna component.

FIGS. 2A-2B illustrate side and backside views of exemplary embodiments of an antenna with an externally integrated transceiver thermally coupled with the antenna structure for conduction of heat transfer.

FIGS. 3A-3C illustrate backside, side and cut-through views of exemplary embodiments of an antenna with an internally mounted integrated transceiver thermally coupled with a backshell of the antenna for conduction of heat transfer.

FIGS. 4A-4B illustrate side and backside views of exemplary embodiments of an antenna with an edge mounted integrated transceiver.

FIGS. 5A-5C illustrate an inside view of a backend and a side view of exemplary embodiments of an antenna with an integrated radio frequency (RF) chain and hot components.

FIG. 6 illustrates the schematic of one embodiment of a cylindrically fed holographic radial aperture antenna.

FIG. 7 illustrates a perspective view of one row of antenna elements that includes a ground plane and a reconfigurable resonator layer.

FIG. 8A illustrates one embodiment of a tunable resonator/slot.

FIG. 8B illustrates a cross section view of one embodiment of a physical antenna aperture.

FIGS. 9A-9D illustrate one embodiment of the different layers for creating the slotted array.

FIG. 10 illustrates a side view of one embodiment of a cylindrically fed antenna structure.

FIG. 11 illustrates another embodiment of the antenna system with an outgoing wave.

FIG. 12 illustrates one embodiment of the placement of matrix drive circuitry with respect to antenna elements.

FIG. 13 illustrates one embodiment of a TFT package.

FIG. 14 is a block diagram of one embodiment of a communication system having simultaneous transmit and receive paths.

### DETAILED DESCRIPTION

Integrated transceivers for antenna systems are disclosed. For one embodiment, an antenna system includes an antenna having a plurality of antenna components, and a transceiver integrated into a structure of the antenna. The transceiver can dissipate heat away from the antenna into the environment. For one embodiment, one of the antenna components is adjacent to and thermally coupled to the transceiver. For one embodiment, one of the adjacent antenna components thermally coupled to the transceiver dissipates heat away from the antenna by conduction, convection, and/or radiation. For another embodiment, the transceiver dissipates heat away from the antenna by convection. The antenna system also includes a single transition pin to couple the output of the transceiver to the antenna. The antenna components can include a backshell or backend of the antenna in which the transceiver can be embedded or integrated with and allow heat to dissipate or spread through by way of conduction, convection, and/or radiation from the transceiver without the transceiver needing an internal thermal management system.

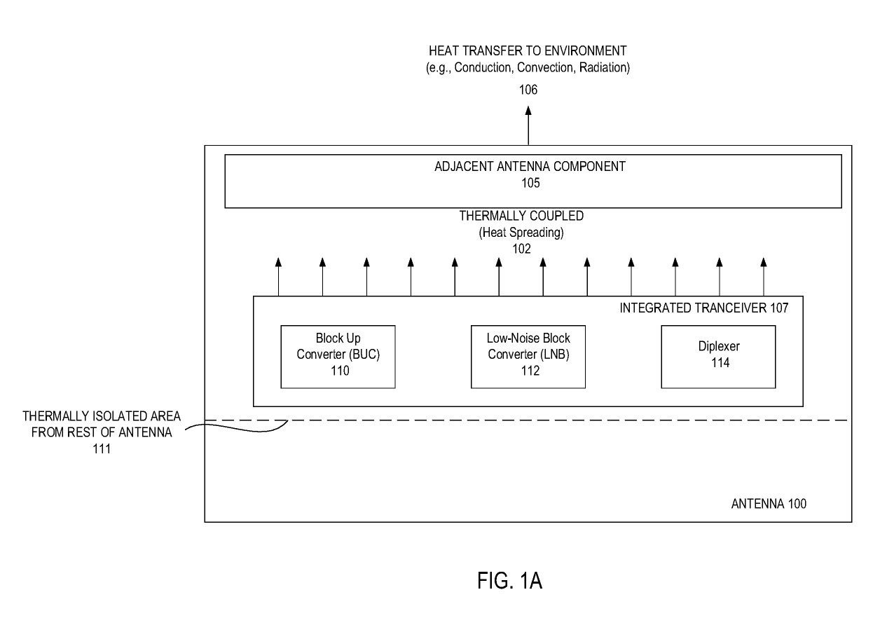

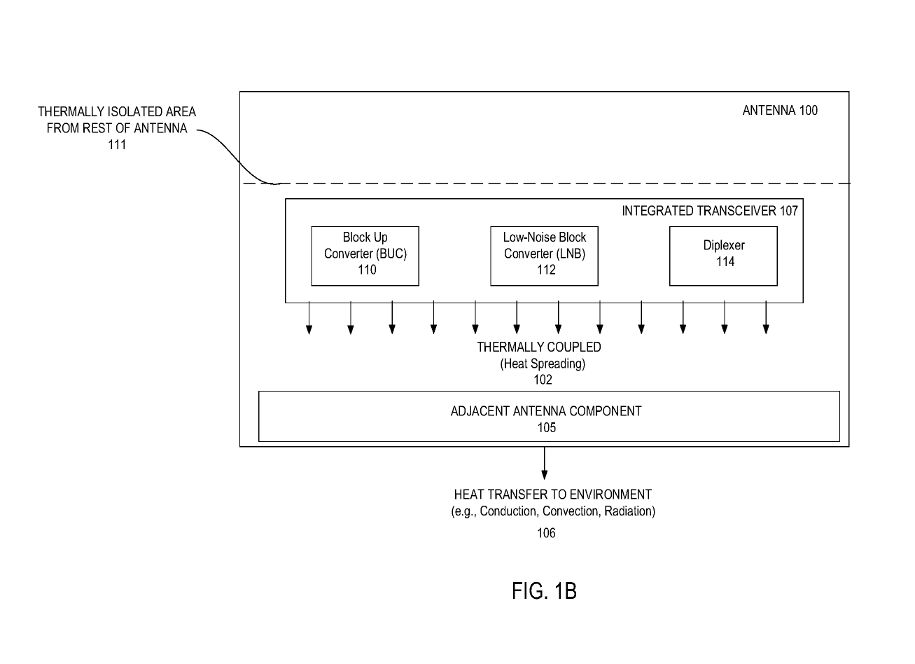

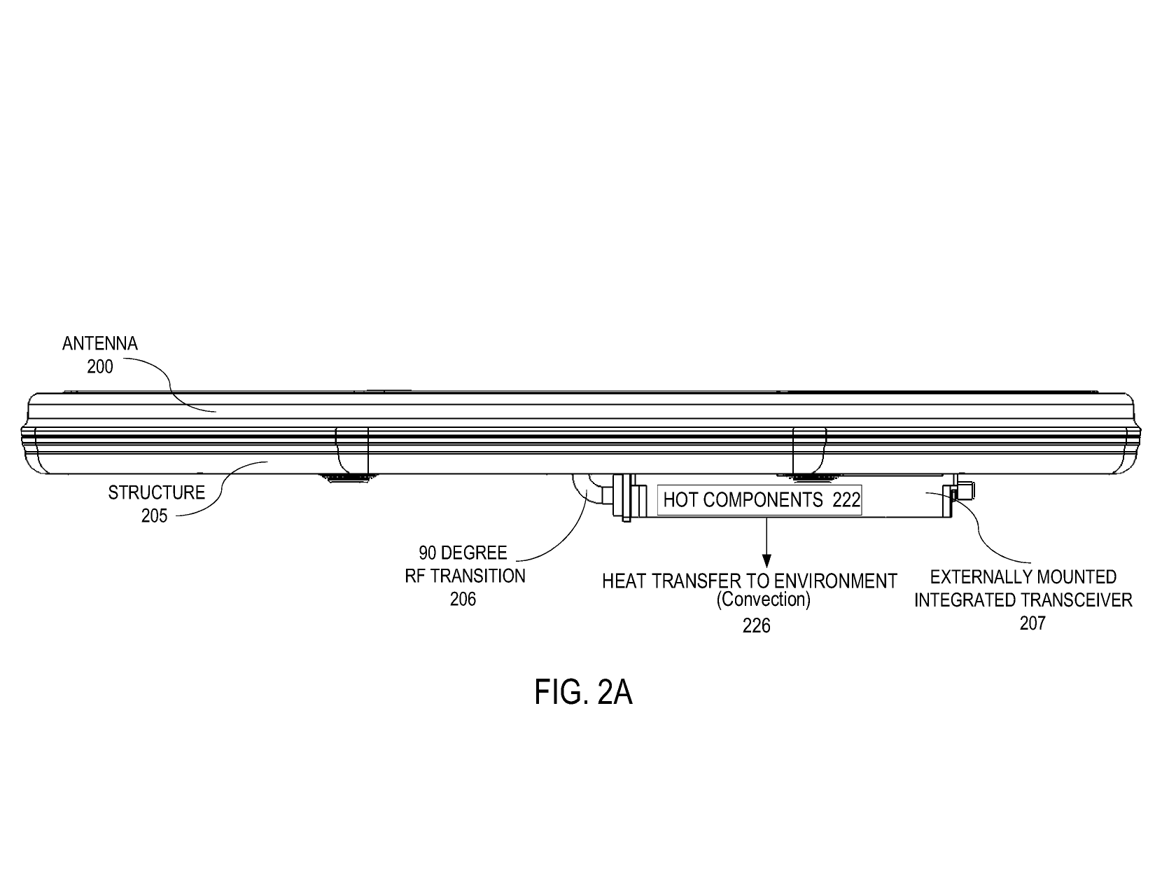

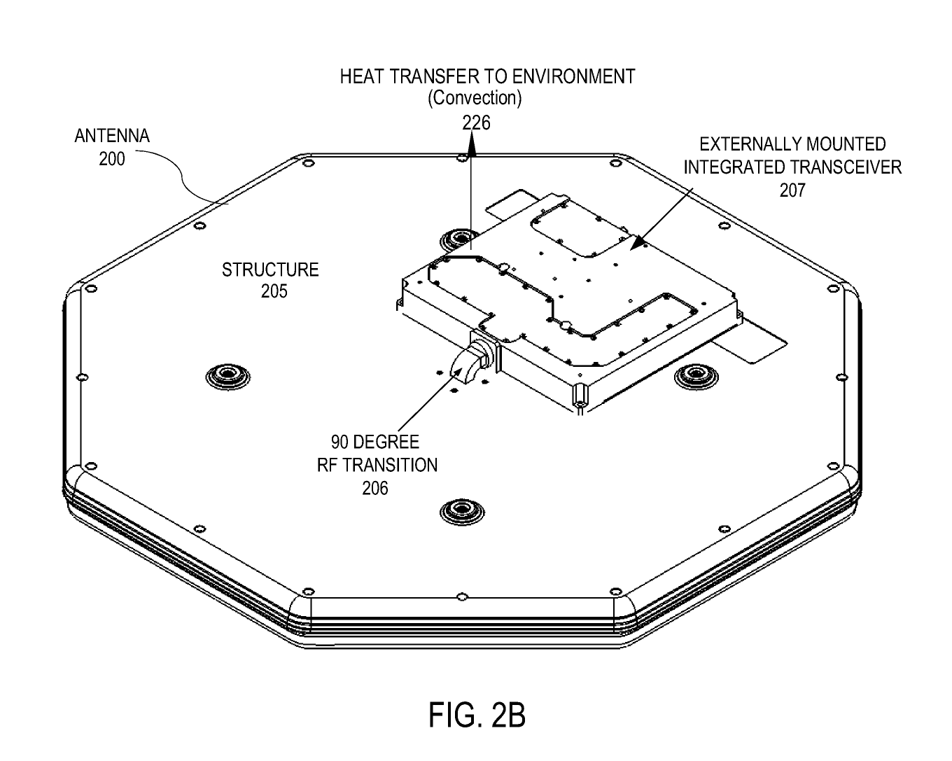

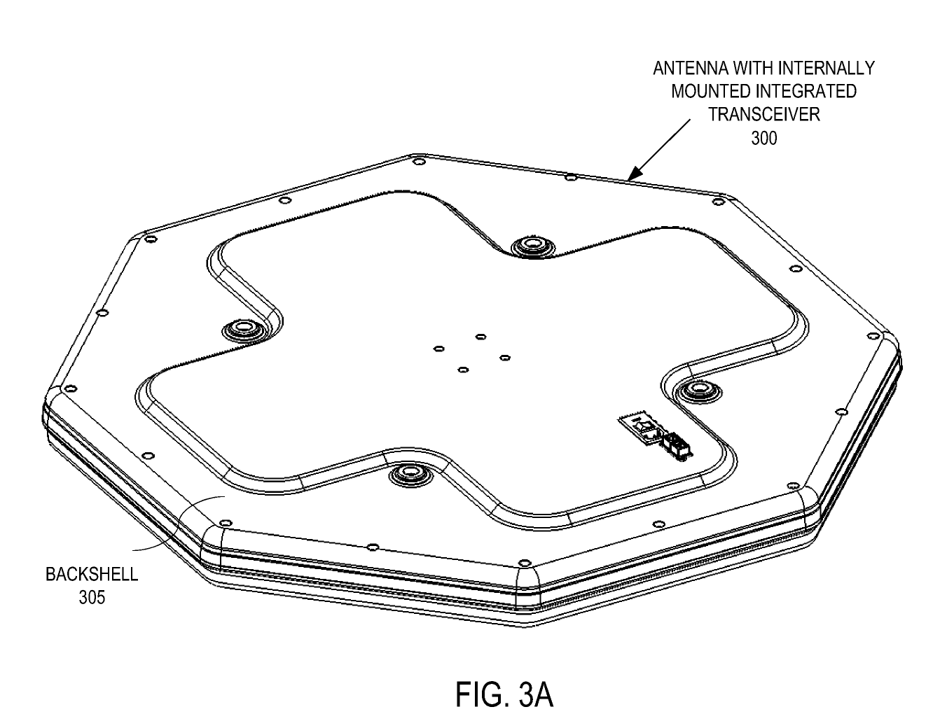

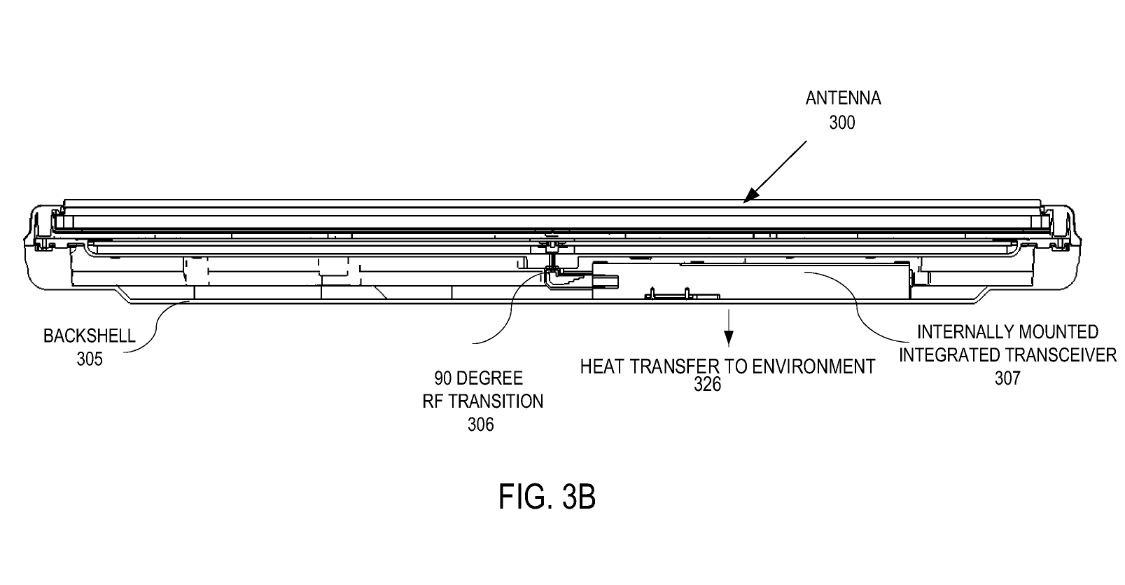

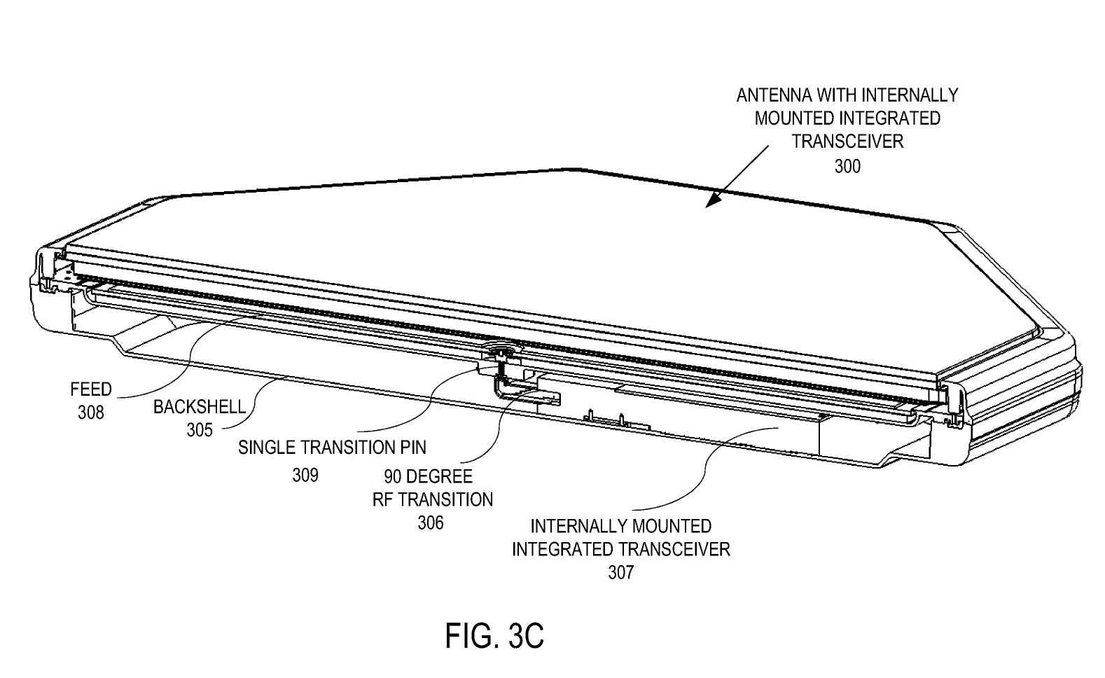

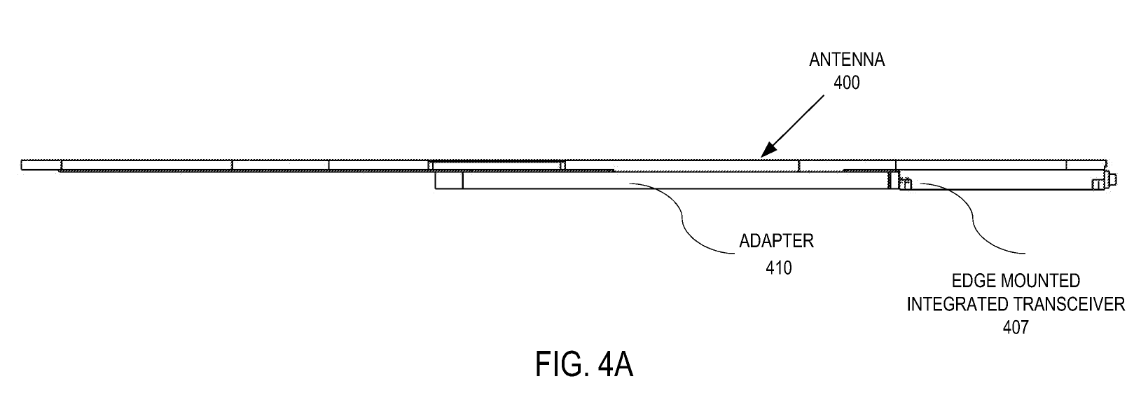

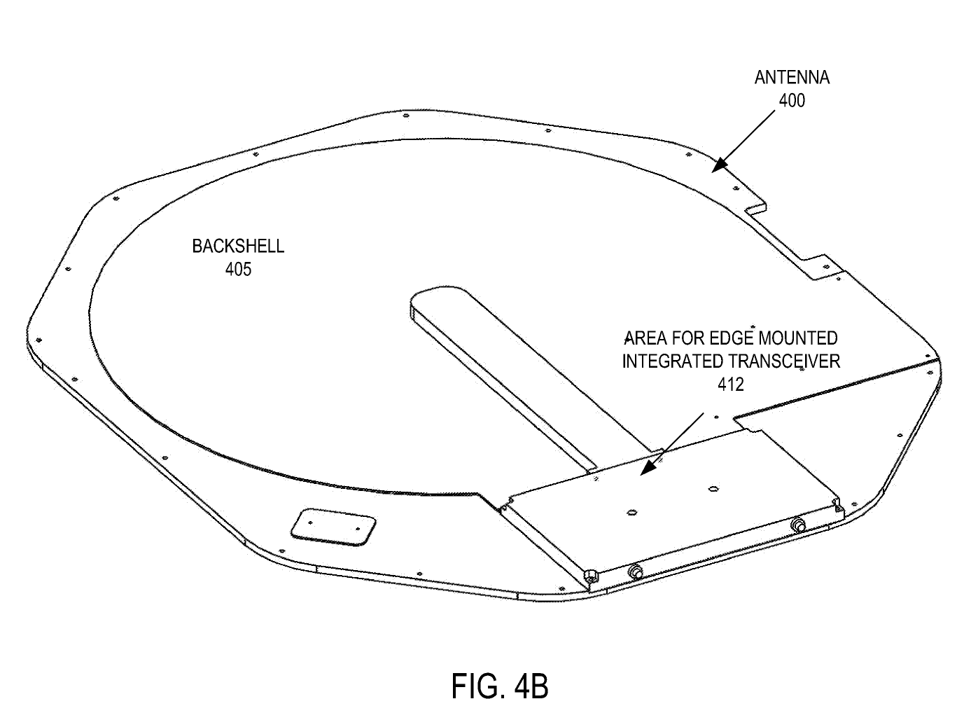

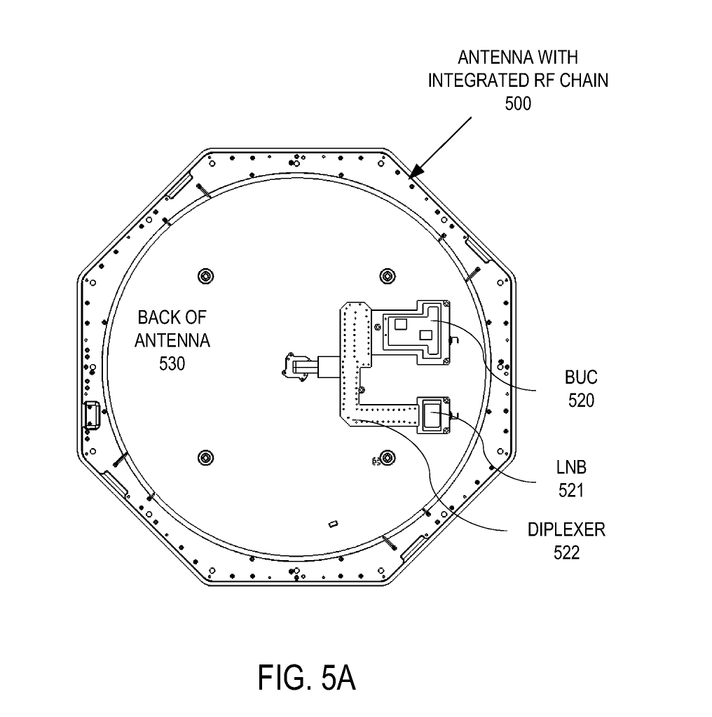

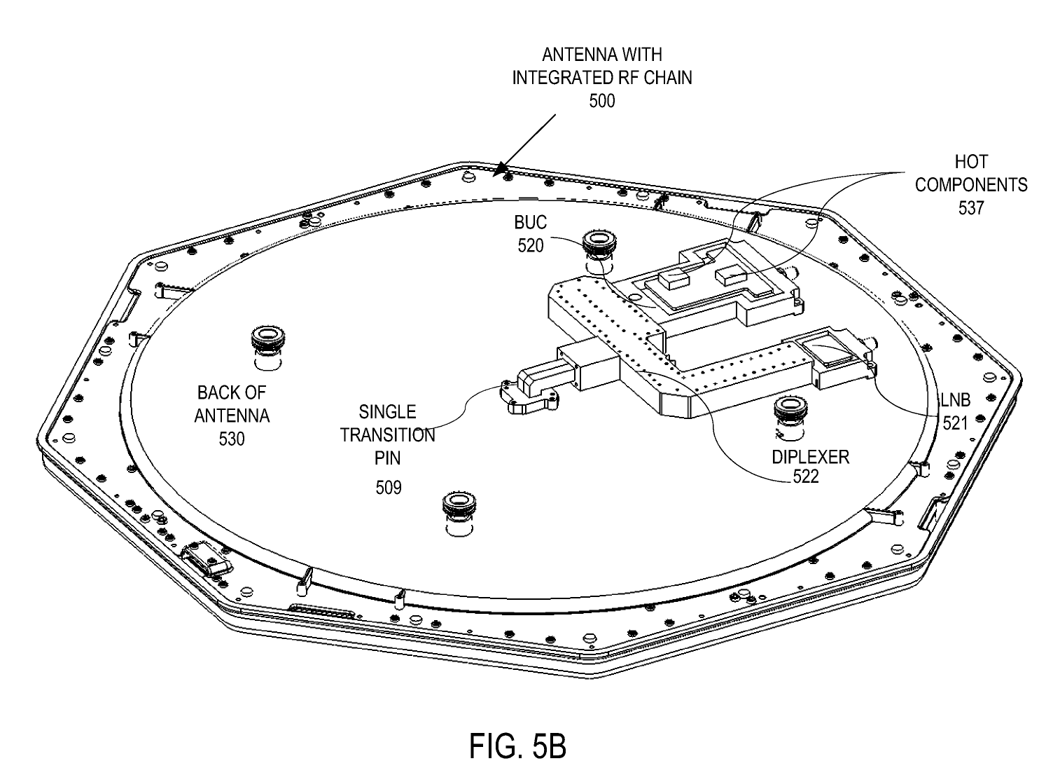

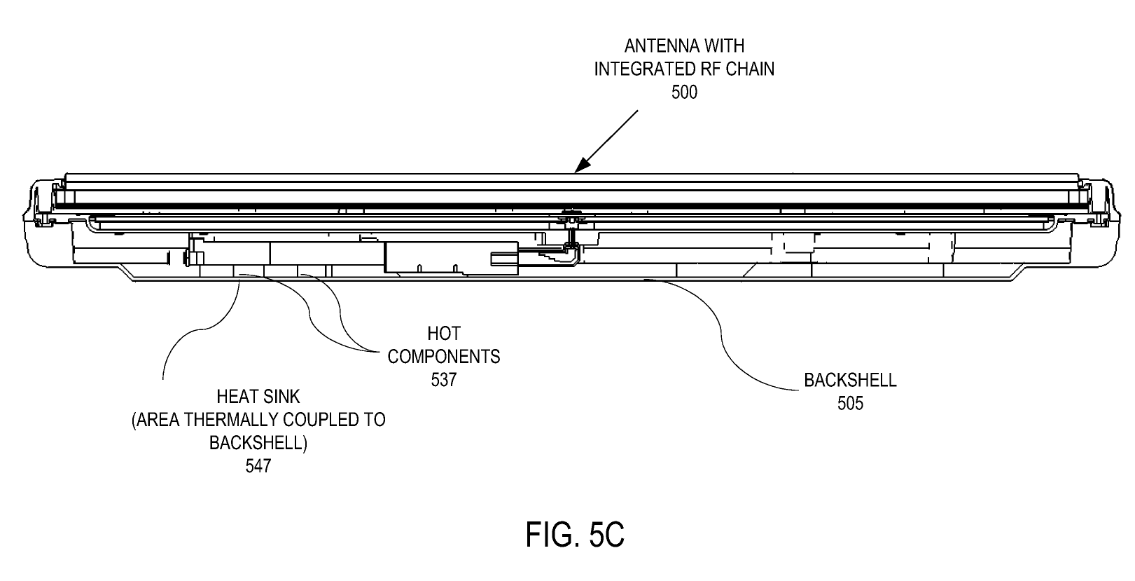

FIGS. 1A-5C describe examples and variations of antenna systems having an integrated transceiver. For example, the transceiver can be externally mounted (FIGS. 2A-2B), internally mounted (FIGS. 3A-3C) or edge mounted (FIGS. 4A-4B) and integrated with the antenna. In another example, components of the transceiver such as a block up-converter (BUC), low-noise block converter (LNB), and a diplexer can create a radio frequency (RF) chain can be embedded and integrated internally into the backend of the antenna (FIGS. 5A-5B). These embodiments are exemplary and any number of variations can be made.

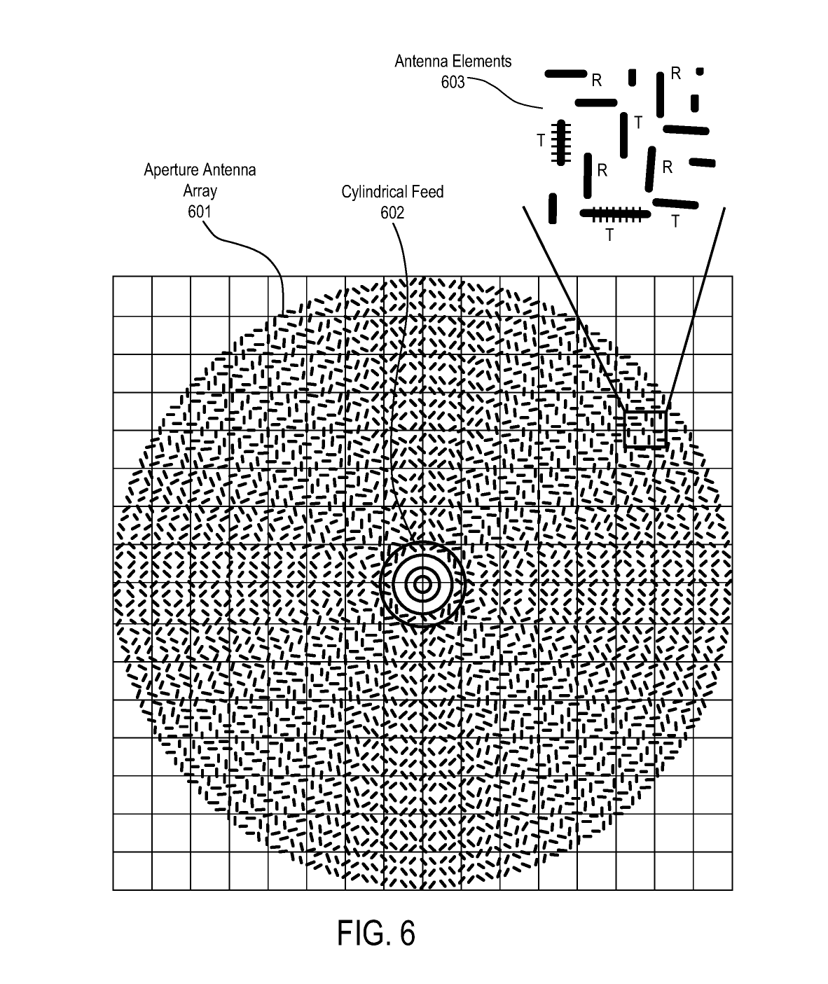

In the following examples, by having the transceiver integrated into the structure of the antenna and thermally coupled to one of its components to dissipate or spread heat, the integrated transceiver can conform to a modular, sleek, and low-profile design that can be easily mounted to an antenna and simplified for mass production. For one example, the integrated transceiver can have a metal cover that can make contact with antenna components such as, e.g., a metal backshell or backend of the antenna. Thus, in one example, heat from the transceiver can dissipate by thermal conduction from the transceiver through the backshell or backend of the antenna. In other examples, heat can dissipate by thermal convection in which the integrated transceiver is in close proximity with the antenna comments such that heat is transferred through the air and antenna components. The disclosed integrated transceivers can be implemented for any type of antenna applications (e.g., antennas as described in FIGS. 6-14). The disclosed integrated transceivers can be implemented for mobile, fixed, and transportable applications. For example, the disclosed integrated transceivers can include, but are not limited to, flat panel antennas for vehicle mounting (e.g., bus, car, sport utility vehicle (SUV), etc.), vessel mounting (e.g., ships, boats, etc.), and on and off shore fixed mounting (e.g., mining, construction sites, energy production, remote monitoring etc.).

In the following description, numerous details are set forth to provide a more thorough explanation of the present invention. It will be apparent, however, that the present invention may be practiced without these specific details. In other instances, well-known structures and devices are shown in block diagram form, rather than in detail, in order to avoid obscuring the present invention.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

### Examples of Antenna with Integrated Transceivers

FIGS. 1A-1B illustrate exemplary block diagrams of an integrated transceiver 107 thermally coupled with at least one adjacent antenna component 105. FIG. 1A shows integrated transceiver 107 having a block up converter (BUC) 110, low-noise converter LNB 112 and a diplexer 114 to provide transmitter and receiver communication for antenna 100. The heat 102 from components 110, 112 and 110, which can be referred to as “hot components” and thermally coupled to adjacent antenna component 105, can spread upwards towards adjacent antenna component 105. In this embodiment, adjacent antenna component 105 transfers heat 106 away from the top of antenna 100 by way of conduction, convection, and/or radiation into the exterior environment. FIG. 1B shows another embodiment in which heat 102 spreads downwards towards adjacent antenna component 105, which is thermally coupled to hot components 110, 112 and 114, that transfers heat 106 away from the bottom of antenna 100 into the environment. In other embodiments, heat 102 can flow in other directions such as laterally and adjacent antenna component 105 can transfer heat 106 away from antenna 100 into the environment. For one embodiment, BUC 110 provides transmission (uplink) of satellite signals for antenna 100. BUC 110 can convert a band of frequencies from a lower frequency to a higher frequency such as converting form L band to Kᵤ band, C band and Kₐ band. For one embodiment, LNB 112 can be a combination of a low-noise amplifier, frequency mixer, local oscillator and intermediate frequency (IF) amplifier used for satellite communications for antenna 100 to receive low level microwave or RF signals for antenna 100, amplify those signals, and changes the signals to a lower frequency band for antenna 100. For one embodiment, diplexer 114 can be an RF splitter/combiner for combining and splitting RF signal feeds for antenna 100 used by BUC 110.

Referring to FIGS. 1A-1B, although adjacent antenna component 105 is shown separated from integrated transceiver 107 for illustration purposes, for one embodiment, integrated transceiver 107 makes contact to an adjacent antenna component 105 in which heat 102 from hot components 110, 112 and 114 is transferred to adjacent component 105 by way of conduction. For example, the adjacent antenna component 105 and integrated transceiver 107 can have a metal cover that makes contact such that the integrated transceiver 107 can dissipate heat 102 to the adjacent antenna component 105 by conduction. For example, heat 102 generated from BUC 110, LNB 112 and diplexer 114 can dissipate or spread to the adjacent antenna component 105 by conduction. In other examples, an air space is between integrated transceiver 107 and adjacent antenna component 105 in which heat 102 generated from hot components 110, 112 and 110 can dissipate or spread to the adjacent antenna component 105 by convection or radiation. For one embodiment, the adjacent antenna component 105 can be a backshell of antenna 100 or part of the inside of the backend of antenna 100, as described in FIGS. 2A-5C, which can spread heat from BUC 110, LNB 112, and diplexer 114 away from antenna 100 into the environment. For one embodiment, antenna 100 includes a thermally isolated area 111 in which heat 102 is isolated from a bottom area or top area of antenna 100. That is, as a result of integrated transceiver 107 being thermally coupled to the adjacent antenna component 105, heat 102 spreads to the adjacent antenna component 105 instead of into the thermally isolated area from rest of antenna 111. In other embodiments, integrated transceiver 107 can be integrated with antenna 100 externally and hot components 110, 112 and 114 can transfer heat away from antenna 100 by convection or radiation to the environment as shown in FIGS. 2A-2B. The integrated transceiver examples of FIGS. 2A-5C can be implemented for flat panel antennas or other types of antennas requiring transceivers.

### (Antenna with Externally Mounted Integrated Transceiver Example)

FIGS. 2A-2B illustrate side and backside views of one embodiment of an antenna 200 with an externally mounted integrated transceiver 207 (integrated transceiver 207) thermally coupled with a structure 205 of the antenna 200. Referring to FIG. 2A, for one embodiment, integrated transceiver 207 is integrated into structure 205 of antenna 200 with a 90-degree or substantially a 90-degree RF transition 206 (transition 206) that provides RF communication between integrated transceiver 207 and antenna 200. For example, transition 206 provides a substantially 90-degree elbow connection with an output interface of integrated transceiver 207 that can route RF communications directly from integrated transceiver 207 to antenna 200. For one embodiment, integrated transceiver 207 can be attached to structure 205 by way of through screws. Other types of attachment or connectors can be used to maintain thermal coupling between integrated transceiver 207 and the structure 205. In this embodiment, integrated transceiver 207 is thermally isolated from antenna 200 and includes hot components 222 located towards the bottom of integrated transceiver 207 such that heat 226 is transferred away from antenna 200 into the environment by convection or radiation.

Referring to FIG. 2B, the backside view shows the modular, flat and low-profile design of the externally mounted integrated transceiver attached to structure 205 (e.g., a backshell of antenna 200) and connected to the antenna 200 by way of RF transition 206. The integrated transceiver 207 design can provide mechanical simplification for mass production and provide cost and complexity reduction to pull heat 226 away from antenna 200 into the environment. Heat 226 can also spread to structure 205 and dissipate into the environment. In this example, integrated transceiver 207 does not require an internal thermal management system and can rely on the antenna system to control heat 226 dissipation generated by hot components 222 such as, e.g., a BUC 110, LNB 112 and diplexer 114, by way of convection into the environment of antenna 200.

### (Antenna with Internally Mounted Integrated Transceiver Example)

FIGS. 3A-3C illustrate backside, side and cut-through views of one embodiment of an antenna 300 with an internally mounted integrated transceiver 307. Referring to FIG. 3A, the backside view is shown where a backshell 305 provides a protective covering for antenna 300 with internally mounted integrated transceiver illustrating a modular design where the integrated transceiver can be part of the antenna 300 assembly. For one embodiment, the backshell 305 can allow heat to spread and dissipate from the internally mounted integrated transceiver 307 away from antenna 300 into the environment.

Referring to FIG. 3B, a side view of antenna 300 is shown where antenna 300 has an internal compartment for housing internally mounted integrated transceiver 307 (integrated transceiver 307) within backshell 305 of antenna 300. In this example, integrated transceiver 307 is embedded within the housing and backshell 305 of antenna 300. RF transition 306 provides a modular connection point for integrated transceiver 307 to be coupled with antenna 300 to minimize the height of the antenna housing and backshell 305 by providing a 90-degree or substantially 90-degree step transition connection point. In this embodiment, heat 326 generated from integrated transceiver 307 can spread towards the bottom of antenna 300 to backshell 305 and dissipate away from antenna 300 into the environment by conduction, convection, and/or radiation. Referring to FIG. 3C, a cut-through view is shown showing a single transition pin 309 that can be used to couple with RF transition 306 that couples an output interface of integrated transceiver 307 to the antenna 300, which can reduce wiring and improve coupling of integrated transceiver 307 with antenna 300. Similarly, integrated transceiver 307 can be attached to backshell 305 by way of through screws or other types of attachments (e.g., pins, rivets, etc.) to allow for thermal coupling between integrated transceiver 307 and at least backshell 305 that allows heat 326 to transfer away from antenna 300 into the environment. In other examples, antenna 300 can include a mounted heat sink or structure to aid in spreading or dissipating heat from integrated transceiver 307 and away from antenna 300.

### (Antenna with Edge Mounted Integrated Transceiver Example)

FIGS. 4A-4B illustrate side and backside views of one embodiment of an antenna 400 with an edge mounted integrated transceiver 407. Referring to FIG. 4A, a side view of antenna 400 is shown where an adapter 410 is located adjacent and coupled to edge mounted integrated transceiver 407. In this example, integrated transceiver 407 is located in an edge compartment at the edge of a housing of antenna 400 and includes BUC, LNB and a diplexer. Although not shown, a transition pin can be formed laterally with integrated transceiver 407 and connect with antenna 400, which can reduce wiring and improve power efficiency for antenna 400. In this example, BUC, LNB and diplexer can be formed as part of the circuitry or components of antenna 400. Referring to FIG. 4B, a backside of antenna 400 is shown illustrating area 412 where edge mounted integrated transceiver 407 is located under the backshell 405. As can be seen, in this example, antenna 400 has a low profile and sleek modular design. Like the other disclosed integrated transceivers, integrated transceiver 407 can be attached to backshell 405 by way of through screws, pins, rivets etc. to allow for thermal coupling between integrated transceiver 407 and at least backshell 405 to dissipate or spread from integrated transceiver 407 away from antenna 400 into the environment. In other examples, antenna 400 can include a mounted heat sink, or structure (not shown) to aid in spreading or dissipating heat from integrated transceiver 407 and away from antenna 400.

### (Antenna with Integrated RF Chain)

FIGS. 5A-5C illustrate inside of backend views and a side view of an antenna 500 with an integrated radio frequency (RF) chain. Referring to FIGS. 5A-5B, backend view of antenna 500 are shown where BUC 520, LNB 521 and diplexer 522 are embedded or mounted into the back of antenna 530, which can be the inside of a backshell of antenna 500. In this example, the RF chain includes BUC 520, LNB 521 and diplexer 522 and a lateral transition pin 509 couples the hot components 537 of integrated transceiver 507 to antenna 500. Referring to FIG. 5C, a side view of antenna 500 is shown where a heat sink 547 includes an area of backshell 505 thermally coupled to the hot components 537. In this example, heat generated from hot components 537, which can include processing elements and circuitry generating heat, can dissipate to heat sink 547 which can be part of backshell 505. For example, heat from elements and circuity for BUC 520 can dissipate or be channeled out through heat sink 547. In this way, the BUC 520 along with the LNB 521 and diplexer 520 are part of the housing or backshell 505 of antenna 500 providing a one assembly antenna with an integrated transceiver.

As shown in the above examples of integrated transceivers, transceiver including a BUC, LNB and diplexer can be integrated with antennas providing a low profile modularity, efficient heat dissipation without requiring additional thermal management systems by spreading heat through at least a backshell or heat sink of the antenna, and providing a step transition with pin in providing low profile connection between the transceiver and antenna.

### Examples of Antenna Embodiments

The integrated transceivers described above may be used with flat panel antennas. Embodiments of such flat panel antennas are disclosed. The flat panel antennas include one or more arrays of antenna elements on an antenna aperture. In one embodiment, the antenna elements comprise liquid crystal cells. In one embodiment, the flat panel antenna is a cylindrically fed antenna that includes matrix drive circuitry to uniquely address and drive each of the antenna elements that are not placed in rows and columns. In one embodiment, the elements are placed in rings.

In one embodiment, the antenna aperture having the one or more arrays of antenna elements is comprised of multiple segments coupled together. When coupled together, the combination of the segments form closed concentric rings of antenna elements. In one embodiment, the concentric rings are concentric with respect to the antenna feed.

### Examples of Antenna Systems

In one embodiment, the flat panel antenna is part of a metamaterial antenna system. Embodiments of a metamaterial antenna system for communications satellite earth stations are described. In one embodiment, the antenna system is a component or subsystem of a satellite earth station (ES) operating on a mobile platform (e.g., aeronautical, maritime, land, etc.) that operates using either Ka-band frequencies or Ku-band frequencies for civil commercial satellite communications. In other embodiments, the antenna system can be used in earth stations that are not on mobile platforms (e.g., fixed or transportable earth stations).

In one embodiment, the antenna system uses surface scattering metamaterial technology to form and steer transmit and receive beams through separate antennas. In one embodiment, the antenna systems are analog systems, in contrast to antenna systems that employ digital signal processing to electrically form and steer beams (such as phased array antennas).

In one embodiment, the antenna system is comprised of three functional subsystems: (1) a wave guiding structure consisting of a cylindrical wave feed architecture; (2) an array of wave scattering metamaterial unit cells that are part of antenna elements; and (3) a control structure to command formation of an adjustable radiation field (beam) from the metamaterial scattering elements using holographic principles.

### Antenna Elements

FIG. 6 illustrates the schematic of one embodiment of a cylindrically fed holographic radial aperture antenna. Referring to FIG. 6, the antenna aperture has one or more arrays 601 of antenna elements 603 that are placed in concentric rings around an input feed 602 of the cylindrically fed antenna. In one embodiment, antenna elements 603 are radio frequency (RF) resonators that radiate RF energy. In one embodiment, antenna elements 603 comprise both Rx and Tx irises that are interleaved and distributed on the whole surface of the antenna aperture. Examples of such antenna elements are described in greater detail below. In embodiment, the RF resonators described herein may be used in antennas that do not include a cylindrical feed.

In one embodiment, the antenna includes a coaxial feed that is used to provide a cylindrical wave feed via input feed 602. In one embodiment, the cylindrical wave feed architecture feeds the antenna from a central point with an excitation that spreads outward in a cylindrical manner from the feed point. That is, a cylindrically fed antenna creates an outward travelling concentric feed wave. Even so, the shape of the cylindrical feed antenna around the cylindrical feed can be circular, square or any shape. In another embodiment, a cylindrically fed antenna creates an inward travelling feed wave. In such a case, the feed wave most naturally comes from a circular structure.

In one embodiment, antenna elements 603 comprise irises and the aperture antenna of FIG. 6 is used to generate a main beam shaped by using excitation from a cylindrical feed wave for radiating irises through tunable liquid crystal (LC) material. In one embodiment, the antenna can be excited to radiate a horizontally or vertically polarized electric field at desired scan angles.

In one embodiment, the antenna elements comprise a group of patch antennas. This group of patch antennas comprises an array of scattering metamaterial elements. In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor. As would be understood by those skilled in the art, LC in the context of CELC refers to inductance-capacitance, as opposed to liquid crystal.

In one embodiment, a liquid crystal (LC) is disposed in the gap around the scattering element. This LC is driven by the direct drive embodiments described above. In one embodiment, liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, in one embodiment, the liquid crystal integrates an on/off switch for the transmission of energy from the guided wave to the CELC. When switched on, the CELC emits an electromagnetic wave like an electrically small dipole antenna. The teachings and techniques disclosed herein are not limited to having a liquid crystal that operates in a binary fashion with respect to energy transmission.

In one embodiment, the feed geometry of this antenna system allows the antenna elements to be positioned at forty-five-degree (45°) angles to the vector of the wave in the wave feed. In one embodiment, other positions may be used (e.g., at 40° angles). This position of the elements enables control of the free space wave received by or transmitted/radiated from the elements. In one embodiment, the antenna elements are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the two sets of elements are perpendicular to each other and simultaneously have equal amplitude excitation if controlled to the same tuning state. Rotating them +/−45 degrees relative to the feed wave excitation achieves both desired features at once. Rotating one set 0 degrees and the other 90 degrees would achieve the perpendicular goal, but not the equal amplitude excitation goal. In one embodiment, 0 and 90 degrees may be used to achieve isolation when feeding the array of antenna elements in a single structure from two sides.

The amount of radiated power from each unit cell is controlled by applying a voltage to the patch (potential across the LC channel) using a controller. Traces to each patch are used to provide the voltage to the patch antenna. The voltage is used to tune or detune the capacitance and thus the resonance frequency of individual elements to effectuate beam forming. The voltage required is dependent on the liquid crystal mixture being used. The voltage tuning characteristic of liquid crystal mixtures is mainly described by a threshold voltage at which the liquid crystal starts to be affected by the voltage and the saturation voltage, above which an increase of the voltage does not cause major tuning in liquid crystal. These two characteristic parameters can change for different liquid crystal mixtures.

In one embodiment, as discussed above, a matrix drive is used to apply voltage to the patches in order to drive each cell separately from all the other cells without having a separate connection for each cell (direct drive). Because of the high density of elements, the matrix drive is an efficient way to address each cell individually.

In one embodiment, the control structure for the antenna system has 2 main components: the antenna array controller, which includes drive electronics, for the antenna system, is below the wave scattering structure, while the matrix drive switching array is interspersed throughout the radiating RF array in such a way as to not interfere with the radiation. In one embodiment, the drive electronics for the antenna system comprise commercial off-the shelf LCD controls used in commercial television appliances that adjust the bias voltage for each scattering element by adjusting the amplitude or duty cycle of an AC bias signal to that element.

In one embodiment, the antenna array controller also contains a microprocessor executing the software. The control structure may also incorporate sensors (e.g., a GPS receiver, a three-axis compass, a 3-axis accelerometer, 3-axis gyro, 3-axis magnetometer, etc.) to provide location and orientation information to the processor. The location and orientation information may be provided to the processor by other systems in the earth station and/or may not be part of the antenna system.

More specifically, the antenna array controller controls which elements are turned off and those elements turned on and at which phase and amplitude level at the frequency of operation. The elements are selectively detuned for frequency operation by voltage application.

For transmission, a controller supplies an array of voltage signals to the RF patches to create a modulation, or control pattern. The control pattern causes the elements to be turned to different states. In one embodiment, multistate control is used in which various elements are turned on and off to varying levels, further approximating a sinusoidal control pattern, as opposed to a square wave (i.e., a sinusoid gray shade modulation pattern). In one embodiment, some elements radiate more strongly than others, rather than some elements radiate and some do not. Variable radiation is achieved by applying specific voltage levels, which adjusts the liquid crystal permittivity to varying amounts, thereby denoting elements variably and causing some elements to radiate more than others.

The generation of a focused beam by the metamaterial array of elements can be explained by the phenomenon of constructive and destructive interference. Individual electromagnetic waves sum up (constructive interference) if they have the same phase when they meet in free space and waves cancel each other (destructive interference) if they are in opposite phase when they meet in free space. If the slots in a slotted antenna are positioned so that each successive slot is positioned at a different distance from the excitation point of the guided wave, the scattered wave from that element will have a different phase than the scattered wave of the previous slot. If the slots are spaced one quarter of a guided wavelength apart, each slot will scatter a wave with a one fourth phase delay from the previous slot.

Using the array, the number of patterns of constructive and destructive interference that can be produced can be increased so that beams can be pointed theoretically in any direction plus or minus ninety degrees (90°) from the bore sight of the antenna array, using the principles of holography. Thus, by controlling which metamaterial unit cells are turned on or off (i.e., by changing the pattern of which cells are turned on and which cells are turned off), a different pattern of constructive and destructive interference can be produced, and the antenna can change the direction of the main beam. The time required to turn the unit cells on and off dictates the speed at which the beam can be switched from one location to another location.

In one embodiment, the antenna system produces one steerable beam for the uplink antenna and one steerable beam for the downlink antenna. In one embodiment, the antenna system uses metamaterial technology to receive beams and to decode signals from the satellite and to form transmit beams that are directed toward the satellite. In one embodiment, the antenna systems are analog systems, in contrast to antenna systems that employ digital signal processing to electrically form and steer beams (such as phased array antennas). In one embodiment, the antenna system is considered a “surface” antenna that is planar and relatively low profile, especially when compared to conventional satellite dish receivers.

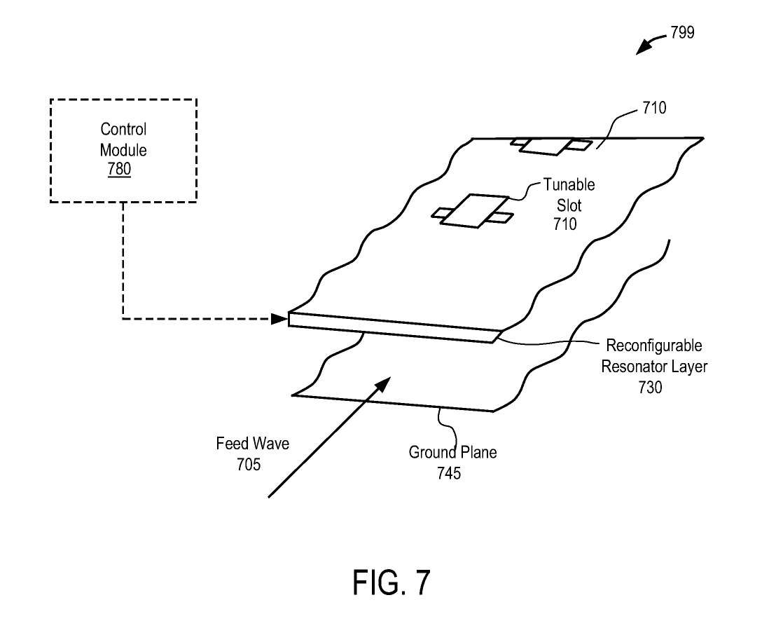

FIG. 7 illustrates a perspective view of one row of antenna elements that includes a ground plane and a reconfigurable resonator layer. Reconfigurable resonator layer 730 includes an array of tunable slots 710. The array of tunable slots 710 can be configured to point the antenna in a desired direction. Each of the tunable slots can be tuned/adjusted by varying a voltage across the liquid crystal.

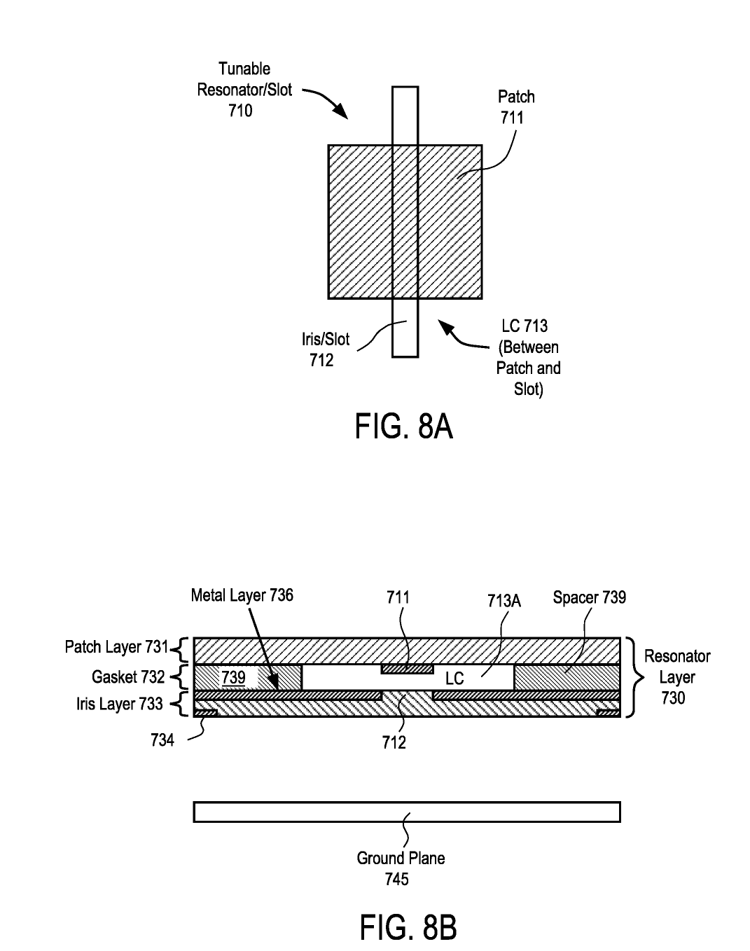

Control module 780 is coupled to reconfigurable resonator layer 730 to modulate the array of tunable slots 710 by varying the voltage across the liquid crystal in FIG. 8A. Control module 780 may include a Field Programmable Gate Array (“FPGA”), a microprocessor, a controller, System-on-a-Chip (SoC), or other processing logic. In one embodiment, control module 780 includes logic circuitry (e.g., multiplexer) to drive the array of tunable slots 710. In one embodiment, control module 780 receives data that includes specifications for a holographic diffraction pattern to be driven onto the array of tunable slots 710. The holographic diffraction patterns may be generated in response to a spatial relationship between the antenna and a satellite so that the holographic diffraction pattern steers the downlink beams (and uplink beam if the antenna system performs transmit) in the appropriate direction for communication. Although not drawn in each figure, a control module similar to control module 780 may drive each array of tunable slots described in the figures of the disclosure.

Radio Frequency (“RF”) holography is also possible using analogous techniques where a desired RF beam can be generated when an RF reference beam encounters an RF holographic diffraction pattern. In the case of satellite communications, the reference beam is in the form of a feed wave, such as feed wave 705 (approximately 20 GHz in some embodiments). To transform a feed wave into a radiated beam (either for transmitting or receiving purposes), an interference pattern is calculated between the desired RF beam (the object beam) and the feed wave (the reference beam). The interference pattern is driven onto the array of tunable slots 710 as a diffraction pattern so that the feed wave is “steered” into the desired RF beam (having the desired shape and direction). In other words, the feed wave encountering the holographic diffraction pattern “reconstructs” the object beam, which is formed according to design requirements of the communication system. The holographic diffraction pattern contains the excitation of each element and is calculated by w_{hologram}=W*ᵢₙWₒᵤₜ, with Wᵢₙ as the wave equation in the waveguide and Wₒᵤₜ the wave equation on the outgoing wave.

FIG. 8A illustrates one embodiment of a tunable resonator/slot 710. Tunable slot 710 includes an iris/slot 712, a radiating patch 711, and liquid crystal 713 disposed between iris 712 and patch 711. In one embodiment, radiating patch 711 is co-located with iris 712.

FIG. 8B illustrates a cross section view of one embodiment of a physical antenna aperture. The antenna aperture includes ground plane 745, and a metal layer 736 within iris layer 733, which is included in reconfigurable resonator layer 730. In one embodiment, the antenna aperture of FIG. 8B includes a plurality of tunable resonator/slots 710 of FIG. 7. Iris/slot 712 is defined by openings in metal layer 736. A feed wave, such as feed wave 705 of FIG. 8A, may have a microwave frequency compatible with satellite communication channels. The feed wave propagates between ground plane 745 and resonator layer 730.

Reconfigurable resonator layer 730 also includes gasket layer 732 and patch layer 731. Gasket layer 732 is disposed between patch layer 731 and iris layer 733. In one embodiment, a spacer could replace gasket layer 732. In one embodiment, iris layer 733 is a printed circuit board (“PCB”) that includes a copper layer as metal layer 736. In one embodiment, iris layer 733 is glass. Iris layer 733 may be other types of substrates.

Openings may be etched in the copper layer to form slots 712. In one embodiment, iris layer 733 is conductively coupled by a conductive bonding layer to another structure (e.g., a waveguide) in FIG. 8B. In one embodiment, the iris layer is not conductively coupled by a conductive bonding layer and is instead interfaced with a non-conducting bonding layer.

Patch layer 731 may also be a PCB that includes metal as radiating patches 711. In one embodiment, gasket layer 732 includes spacers 739 that provide a mechanical standoff to define the dimension between metal layer 736 and patch 711. In one embodiment, the spacers are 75 microns, but other sizes may be used (e.g., 3-200 mm). As mentioned above, in one embodiment, the antenna aperture of FIG. 8B includes multiple tunable resonator/slots, such as tunable resonator/slot 710 includes patch 711, liquid crystal 713, and iris 712 of FIG. 8A. The chamber for liquid crystal 713 is defined by spacers 739, iris layer 733 and metal layer 736. When the chamber is filled with liquid crystal, patch layer 731 can be laminated onto spacers 739 to seal liquid crystal within resonator layer 730.

A voltage between patch layer 731 and iris layer 733 can be modulated to tune the liquid crystal in the gap between the patch and the slots (e.g., tunable resonator/slot 710). Adjusting the voltage across liquid crystal 713 varies the capacitance of a slot (e.g., tunable resonator/slot 710). Accordingly, the reactance of a slot (e.g., tunable resonator/slot 710) can be varied by changing the capacitance. Resonant frequency of slot 710 also changes according to the equation

$$f = \frac{1}{2 π \sqrt{LC}}$$

where j is the resonant frequency of slot 710 and L and C are the inductance and capacitance of slot 710, respectively. The resonant frequency of slot 710 affects the energy radiated from feed wave 705 propagating through the waveguide. As an example, if feed wave 1205 is 20 GHz, the resonant frequency of a slot 710 may be adjusted (by varying the capacitance) to 17 GHz so that the slot 710 couples substantially no energy from feed wave 705. Or, the resonant frequency of a slot 710 may be adjusted to 20 GHz so that the slot 710 couples energy from feed wave 705 and radiates that energy into free space. Although the examples given are binary (fully radiating or not radiating at all), full gray scale control of the reactance, and therefore the resonant frequency of slot 710 is possible with voltage variance over a multi-valued range. Hence, the energy radiated from each slot 710 can be finely controlled so that detailed holographic diffraction patterns can be formed by the array of tunable slots.

In one embodiment, tunable slots in a row are spaced from each other by λ/5. Other spacings may be used. In one embodiment, each tunable slot in a row is spaced from the closest tunable slot in an adjacent row by λ/2, and, thus, commonly oriented tunable slots in different rows are spaced by λ/4, though other spacings are possible (e.g., λ/5, λ/6.3). In another embodiment, each tunable slot in a row is spaced from the closest tunable slot in an adjacent row by λ/3.

Embodiments use reconfigurable metamaterial technology, such as described in U.S. patent application Ser. No. 14/550,178, entitled “Dynamic Polarization and Coupling Control from a Steerable Cylindrically Fed Holographic Antenna”, filed Nov. 21, 2014 and U.S. patent application Ser. No. 14/610,502, entitled “Ridged Waveguide Feed Structures for Reconfigurable Antenna”, filed Jan. 30, 2015.

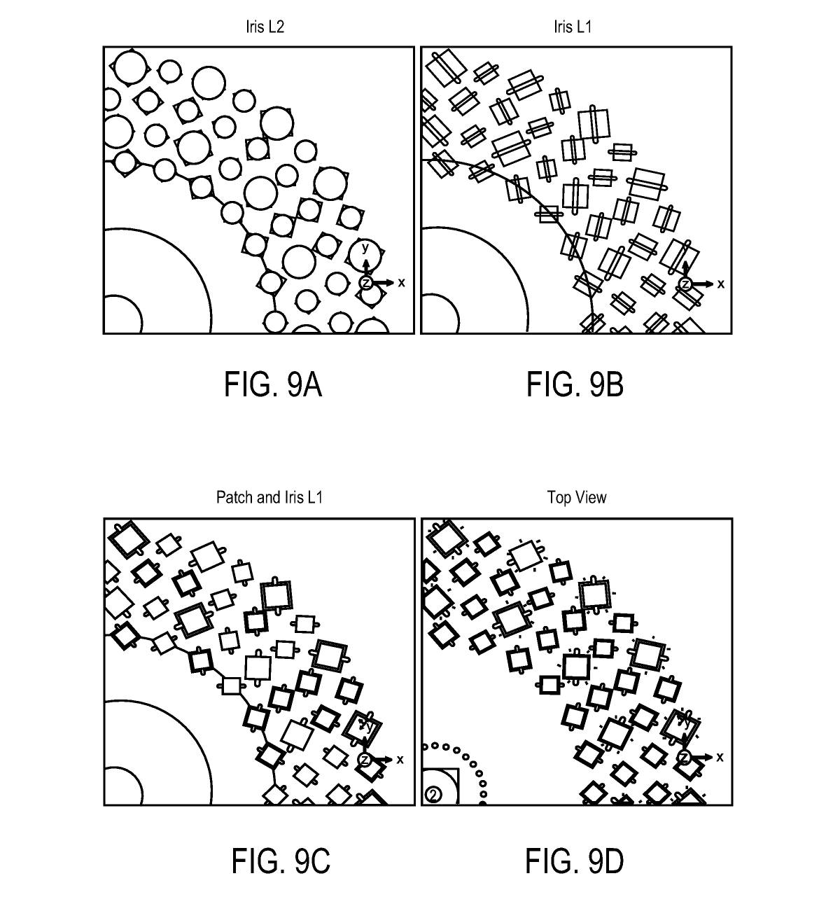

FIGS. 9A-9D illustrate one embodiment of the different layers for creating the slotted array. The antenna array includes antenna elements that are positioned in rings, such as the example rings shown in FIG. 6. In this example, the antenna array may have two different types of antenna elements that are used for two different types of frequency bands.

FIG. 9A illustrates a portion of the first iris board layer with locations corresponding to the slots. Referring to FIG. 9A, the circles are open areas/slots in the metallization in the bottom side of the iris substrate, and are for controlling the coupling of elements to the feed (the feed wave). In one embodiment, this layer is an optional layer and is not used in all designs. FIG. 9B illustrates a portion of the second iris board layer containing slots. FIG. 9C illustrates patches over a portion of the second iris board layer. FIG. 9D illustrates a top view of a portion of the slotted array.

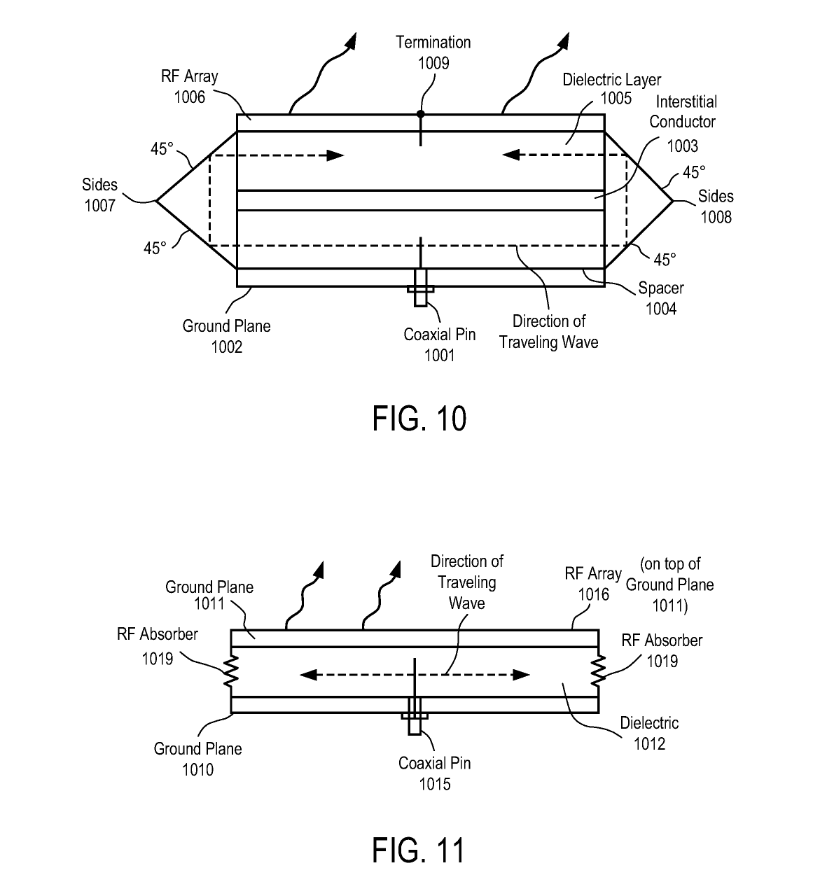

FIG. 10 illustrates a side view of one embodiment of a cylindrically fed antenna structure. The antenna produces an inwardly travelling wave using a double layer feed structure (i.e., two layers of a feed structure). In one embodiment, the antenna includes a circular outer shape, though this is not required. That is, non-circular inward travelling structures can be used. In one embodiment, the antenna structure in FIG. 10 includes a coaxial feed, such as, for example, described in U.S. Publication No. 2015/0236412, entitled “Dynamic Polarization and Coupling Control from a Steerable Cylindrically Fed Holographic Antenna”, filed on Nov. 21, 2014.

Referring to FIG. 10, a coaxial pin 1001 is used to excite the field on the lower level of the antenna. In one embodiment, coaxial pin 1001 is a 50 Ω coax pin that is readily available. Coaxial pin 1001 is coupled (e.g., bolted) to the bottom of the antenna structure, which is conducting ground plane 1002.

Separate from conducting ground plane 1002 is interstitial conductor 1003, which is an internal conductor. In one embodiment, conducting ground plane 1002 and interstitial conductor 1003 are parallel to each other. In one embodiment, the distance between ground plane 1002 and interstitial conductor 1003 is 0.1-0.15″. In another embodiment, this distance may be λ/2, where λ is the wavelength of the travelling wave at the frequency of operation.

Ground plane 1002 is separated from interstitial conductor 1003 via a spacer 1004. In one embodiment, spacer 1004 is a foam or air-like spacer. In one embodiment, spacer 1004 comprises a plastic spacer.

On top of interstitial conductor 1003 is dielectric layer 1005. In one embodiment, dielectric layer 1005 is plastic. The purpose of dielectric layer 1005 is to slow the travelling wave relative to free space velocity. In one embodiment, dielectric layer 1005 slows the travelling wave by 30% relative to free space. In one embodiment, the range of indices of refraction that are suitable for beam forming are 1.2-1.8, where free space has by definition an index of refraction equal to 1. Other dielectric spacer materials, such as, for example, plastic, may be used to achieve this effect. In one embodiment, materials other than plastic may be used as long as they achieve the desired wave slowing effect. Alternatively, a material with distributed structures may be used as dielectric 1005, such as periodic sub-wavelength metallic structures that can be machined or lithographically defined, for example.

An RF-array 1006 is on top of dielectric 1005. In one embodiment, the distance between interstitial conductor 1003 and RF-array 1006 is 0.1-0.15″. In another embodiment, this distance may be λ_{eff}/2, where λ_{eff} is the effective wavelength in the medium at the design frequency.

The antenna includes sides 1007 and 1008. Sides 1007 and 1008 are angled to cause a travelling wave feed from coax pin 1001 to be propagated from the area below interstitial conductor 1003 (the spacer layer) to the area above interstitial conductor 1003 (the dielectric layer) via reflection. In one embodiment, the angle of sides 1007 and 1008 are at 45° angles. In an alternative embodiment, sides 1007 and 1008 could be replaced with a continuous radius to achieve the reflection. While FIG. 10 shows angled sides that have angle of 45 degrees, other angles that accomplish signal transmission from lower level feed to upper level feed may be used. That is, given that the effective wavelength in the lower feed will generally be different than in the upper feed, some deviation from the ideal 45° angles could be used to aid transmission from the lower to the upper feed level. For example, in another embodiment, the 45° angles are replaced with a single step. The steps on one end of the antenna go around the dielectric layer, interstitial the conductor, and the spacer layer. The same two steps are at the other ends of these layers.

In operation, when a feed wave is fed in from coaxial pin 1001, the wave travels outward concentrically oriented from coaxial pin 1001 in the area between ground plane 1002 and interstitial conductor 1003. The concentrically outgoing waves are reflected by sides 1007 and 1008 and travel inwardly in the area between interstitial conductor 1003 and RF array 1006. The reflection from the edge of the circular perimeter causes the wave to remain in phase (i.e., it is an in-phase reflection). The travelling wave is slowed by dielectric layer 1005. At this point, the travelling wave starts interacting and exciting with elements in RF array 1006 to obtain the desired scattering.

To terminate the travelling wave, a termination 1009 is included in the antenna at the geometric center of the antenna. In one embodiment, termination 1009 comprises a pin termination (e.g., a 50 Ω pin). In another embodiment, termination 1009 comprises an RF absorber that terminates unused energy to prevent reflections of that unused energy back through the feed structure of the antenna. These could be used at the top of RF array 1006.

FIG. 11 illustrates another embodiment of the antenna system with an outgoing wave. Referring to FIG. 11, two ground planes 1010 and 1011 are substantially parallel to each other with a dielectric layer 1012 (e.g., a plastic layer, etc.) in between ground planes. RF absorbers 1019 (e.g., resistors) couple the two ground planes 1010 and 1011 together. A coaxial pin 1015 (e.g., 50 Ω) feeds the antenna. An RF array 1016 is on top of dielectric layer 1012 and ground plane 1011.

In operation, a feed wave is fed through coaxial pin 1015 and travels concentrically outward and interacts with the elements of RF array 1016.

The cylindrical feed in both the antennas of FIGS. 10 and 11 improves the service angle of the antenna. Instead of a service angle of plus or minus forty-five degrees azimuth (±45° Az) and plus or minus twenty-five degrees elevation (±25° E1), in one embodiment, the antenna system has a service angle of seventy-five degrees (75°) from the bore sight in all directions. As with any beam forming antenna comprised of many individual radiators, the overall antenna gain is dependent on the gain of the constituent elements, which themselves are angle-dependent. When using common radiating elements, the overall antenna gain typically decreases as the beam is pointed further off bore sight. At 75 degrees off bore sight, significant gain degradation of about 6 dB is expected.

Embodiments of the antenna having a cylindrical feed solve one or more problems. These include dramatically simplifying the feed structure compared to antennas fed with a corporate divider network and therefore reducing total required antenna and antenna feed volume; decreasing sensitivity to manufacturing and control errors by maintaining high beam performance with coarser controls (extending all the way to simple binary control); giving a more advantageous side lobe pattern compared to rectilinear feeds because the cylindrically oriented feed waves result in spatially diverse side lobes in the far field; and allowing polarization to be dynamic, including allowing left-hand circular, right-hand circular, and linear polarizations, while not requiring a polarizer.

### Array of Wave Scattering Elements

RF array 1006 of FIG. 10 and RF array 1016 of FIG. 11 include a wave scattering subsystem that includes a group of patch antennas (i.e., scatterers) that act as radiators. This group of patch antennas comprises an array of scattering metamaterial elements.

In one embodiment, each scattering element in the antenna system is part of a unit cell that consists of a lower conductor, a dielectric substrate and an upper conductor that embeds a complementary electric inductive-capacitive resonator (“complementary electric LC” or “CELL”) that is etched in or deposited onto the upper conductor.

In one embodiment, a liquid crystal (LC) is injected in the gap around the scattering element. Liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, the liquid crystal acts as an on/off switch for the transmission of energy from the guided wave to the CELC. When switched on, the CELC emits an electromagnetic wave like an electrically small dipole antenna.

Controlling the thickness of the LC increases the beam switching speed. A fifty percent (50%) reduction in the gap between the lower and the upper conductor (the thickness of the liquid crystal) results in a fourfold increase in speed. In another embodiment, the thickness of the liquid crystal results in a beam switching speed of approximately fourteen milliseconds (14 ms). In one embodiment, the LC is doped in a manner well-known in the art to improve responsiveness so that a seven millisecond (7 ms) requirement can be met.

The CELC element is responsive to a magnetic field that is applied parallel to the plane of the CELC element and perpendicular to the CELC gap complement. When a voltage is applied to the liquid crystal in the metamaterial scattering unit cell, the magnetic field component of the guided wave induces a magnetic excitation of the CELC, which, in turn, produces an electromagnetic wave in the same frequency as the guided wave.

The phase of the electromagnetic wave generated by a single CELC can be selected by the position of the CELC on the vector of the guided wave. Each cell generates a wave in phase with the guided wave parallel to the CELC. Because the CELCs are smaller than the wave length, the output wave has the same phase as the phase of the guided wave as it passes beneath the CELC.

In one embodiment, the cylindrical feed geometry of this antenna system allows the CELC elements to be positioned at forty-five-degree (45°) angles to the vector of the wave in the wave feed. This position of the elements enables control of the polarization of the free space wave generated from or received by the elements. In one embodiment, the CELCs are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the CELCs are implemented with patch antennas that include a patch co-located over a slot with liquid crystal between the two. In this respect, the metamaterial antenna acts like a slotted (scattering) wave guide. With a slotted wave guide, the phase of the output wave depends on the location of the slot in relation to the guided wave.

### Cell Placement

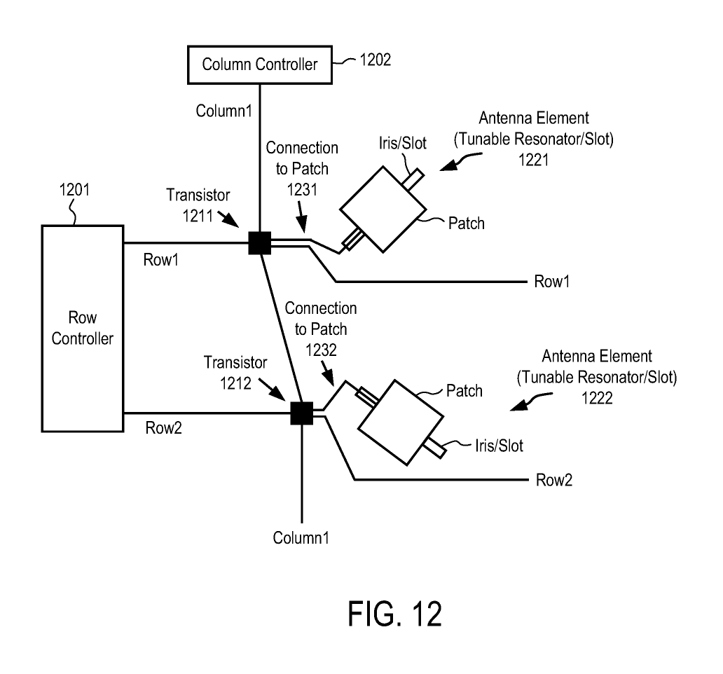

In one embodiment, the antenna elements are placed on the cylindrical feed antenna aperture in a way that allows for a systematic matrix drive circuit. The placement of the cells includes placement of the transistors for the matrix drive. FIG. 12 illustrates one embodiment of the placement of matrix drive circuitry with respect to antenna elements. Referring to FIG. 12, row controller 1201 is coupled to transistors 1211 and 1212, via row select signals Row1 and Row2, respectively, and column controller 1202 is coupled to transistors 1211 and 1212 via column select signal Column1. Transistor 1211 is also coupled to antenna element 1221 via connection to patch 1231, while transistor 1212 is coupled to antenna element 1222 via connection to patch 1232.

In an initial approach to realize matrix drive circuitry on the cylindrical feed antenna with unit cells placed in a non-regular grid, two steps are performed. In the first step, the cells are placed on concentric rings and each of the cells is connected to a transistor that is placed beside the cell and acts as a switch to drive each cell separately. In the second step, the matrix drive circuitry is built in order to connect every transistor with a unique address as the matrix drive approach requires. Because the matrix drive circuit is built by row and column traces (similar to LCDs) but the cells are placed on rings, there is no systematic way to assign a unique address to each transistor. This mapping problem results in very complex circuitry to cover all the transistors and leads to a significant increase in the number of physical traces to accomplish the routing. Because of the high density of cells, those traces disturb the RF performance of the antenna due to coupling effect. Also, due to the complexity of traces and high packing density, the routing of the traces cannot be accomplished by commercially available layout tools.

In one embodiment, the matrix drive circuitry is predefined before the cells and transistors are placed. This ensures a minimum number of traces that are necessary to drive all the cells, each with a unique address. This strategy reduces the complexity of the drive circuitry and simplifies the routing, which subsequently improves the RF performance of the antenna.

More specifically, in one approach, in the first step, the cells are placed on a regular rectangular grid composed of rows and columns that describe the unique address of each cell. In the second step, the cells are grouped and transformed to concentric circles while maintaining their address and connection to the rows and columns as defined in the first step. A goal of this transformation is not only to put the cells on rings but also to keep the distance between cells and the distance between rings constant over the entire aperture. In order to accomplish this goal, there are several ways to group the cells.

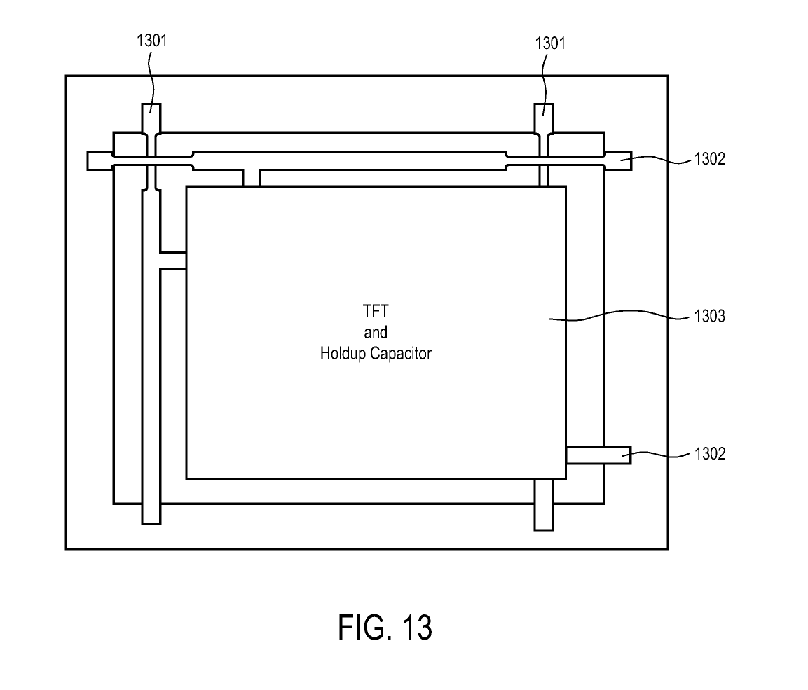

In one embodiment, a TFT package is used to enable placement and unique addressing in the matrix drive. FIG. 13 illustrates one embodiment of a TFT package. Referring to FIG. 13, a TFT and a hold capacitor 1303 is shown with input and output ports. There are two input ports connected to traces 1301 and two output ports connected to traces 1302 to connect the TFTs together using the rows and columns. In one embodiment, the row and column traces cross in 90° angles to reduce, and potentially minimize, the coupling between the row and column traces. In one embodiment, the row and column traces are on different layers.

### An Example of Full Duplex Communication System

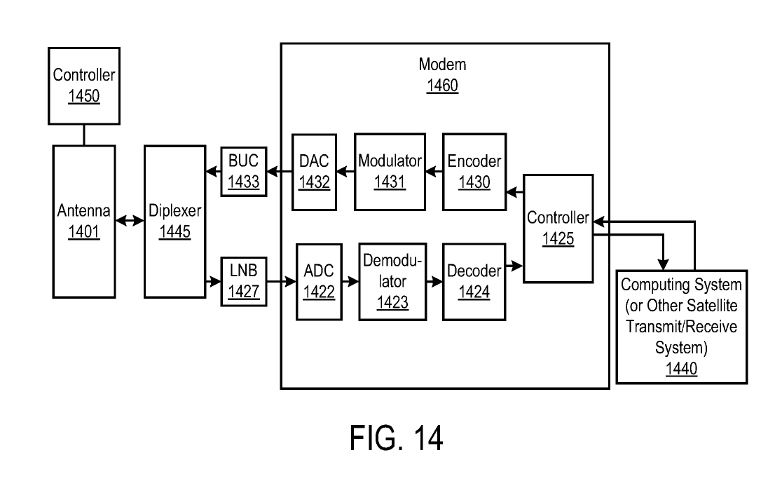

In another embodiment, the combined antenna apertures are used in a full duplex communication system. FIG. 14 is a block diagram of another embodiment of a communication system having simultaneous transmit and receive paths. While only one transmit path and one receive path are shown, the communication system may include more than one transmit path and/or more than one receive path.

Referring to FIG. 14, antenna 1401 includes two spatially interleaved antenna arrays operable independently to transmit and receive simultaneously at different frequencies as described above. In one embodiment, antenna 1401 is coupled to diplexer 1445. The coupling may be by one or more feeding networks. In one embodiment, in the case of a radial feed antenna, diplexer 1445 combines the two signals and the connection between antenna 1401 and diplexer 1445 is a single broad-band feeding network that can carry both frequencies.

Diplexer 1445 is coupled to a low noise block down converter (LNBs) 1427, which performs a noise filtering function and a down conversion and amplification function in a manner well-known in the art. In one embodiment, LNB 1427 is in an out-door unit (ODU). In another embodiment, LNB 1427 is integrated into the antenna apparatus. LNB 1427 is coupled to a modem 1460, which is coupled to computing system 1440 (e.g., a computer system, modem, etc.).

Modem 1460 includes an analog-to-digital converter (ADC) 1422, which is coupled to LNB 1427, to convert the received signal output from diplexer 1445 into digital format. Once converted to digital format, the signal is demodulated by demodulator 1423 and decoded by decoder 1424 to obtain the encoded data on the received wave. The decoded data is then sent to controller 1425, which sends it to computing system 1440.

Modem 1460 also includes an encoder 1430 that encodes data to be transmitted from computing system 1440. The encoded data is modulated by modulator 1431 and then converted to analog by digital-to-analog converter (DAC) 1432. The analog signal is then filtered by a BUC (up-convert and high pass amplifier) 1433 and provided to one port of diplexer 1445. In one embodiment, BUC 1433 is in an out-door unit (ODU).

Diplexer 1445 operating in a manner well-known in the art provides the transmit signal to antenna 1401 for transmission.

Controller 1450 controls antenna 1401, including the two arrays of antenna elements on the single combined physical aperture.

The communication system would be modified to include the combiner/arbiter described above. In such a case, the combiner/arbiter after the modem but before the BUC and LNB.

In one embodiment, the full duplex communication system shown in FIG. 14 can have a number of applications, including but not limited to, internet communication, vehicle communication (including software updating), etc.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

In the foregoing specification, the invention has been described with reference to specific exemplary embodiments thereof. It will, however, be evident that various modifications and changes may be made thereto without departing from the broader spirit and scope of disclosed embodiments. The specification and drawings are, accordingly, to be regarded in an illustrative rather than a restrictive sense.

What is claimed is:

1. An antenna system comprising:
an antenna having a plurality of antenna components; and
a transceiver integrated into a structure of the antenna, wherein the transceiver dissipates heat from the transceiver away from the antenna.

2. The antenna system of claim 1, wherein one of the antenna components is adjacent and thermally coupled to the transceiver.

3. The antenna system of claim 2, wherein one of the antenna components thermally coupled to the transceiver dissipates heat away from the antenna by conduction, convection, and/or radiation.

4. The antenna system of claim 1, wherein the transceiver dissipates heat away from the antenna by convection.

5. The antenna system of claim 3 or 4, wherein heat is dissipated away from the antenna into an environment of the antenna.

6. The antenna system of claim 1, wherein the transceiver is externally mounted, internally mounted or edge mounted to a structure of the antenna.

7. The antenna system of claim 2, wherein one of the thermally coupled antenna components includes a backshell or backend of the antenna.

8. The antenna system of claim 7, wherein transceiver includes a block up-converter (BUC), low-noise block converter (LNB), and a diplexer embedded into the backend of the antenna.

9. The antenna system of claim 8, wherein heat from at least the BUC spreads through the backend of the antenna.

10. The antenna system of claim 1, further comprising:
a single transition pin to couple an output of the transceiver to the antenna.

11. The antenna system of claim 10, further comprising:
a radio frequency (RF) transition to provide RF communication between the integrated transceiver and antenna.

12. The antenna system of claim 11, wherein the RF transition provides a 90-degree or substantially 90-degree elbow transition to interface the integrated transceiver with the antenna.

13. An antenna comprising:
a plurality of antenna components; and
a transceiver integrated into a structure of the antenna configured to provide transmitter and receiver communications, wherein the transceiver dissipates heat away from the antenna.

14. The antenna of claim 13, wherein the heat dissipates away from the antenna into an environment by conduction, convection, and/or radiation.

15. The antenna of claim 13, wherein the transceiver transfers heat away from the antenna by convection.

16. The antenna of claim 13, wherein one of the antenna components is adjacent and thermally coupled to the transceiver, and wherein the transceiver dissipates away from the antenna through an adjacent and thermally coupled antenna component.

17. The antenna of claim 13, wherein the transceiver is externally mounted, internally mounted or edge mounted to the structure of the antenna.

18. The antenna of claim 17, wherein transceiver includes a block up-converter (BUC), low-noise block converter (LNB), and a diplexer.

19. The antenna of claim 18, wherein the BUC, LNB and diplexer are embedded or mounted into the backend of the antenna.

20. The antenna of claim 19, wherein heat from at least the BUC spreads through the backend of the antenna.

21. The antenna of claim 13, further comprising:
a single transition pin to couple an output of the transceiver to the antenna.

22. The antenna of claim 21, further comprising:
a radio frequency (RF) transition to provide RF communication between the integrated transceiver and antenna.

23. The antenna of claim 22, wherein the RF transition provides a 90-degree or substantially 90-degree elbow transition to interface the integrated transceiver with the antenna.

24. An antenna comprising:
a plurality of antenna components including a backshell and a backend; and
a transceiver integrated into the backshell or backend, wherein the transceiver includes a block up converter (BUC), low-noise block converter (LNB), and a diplexer and configured to dissipate heat into an environment of the antenna.
